(19) United States
(12) Patent Application Publication
(10) Pub. No.: US 2015/0292562 A1
(43) Pub. Date: Oct. 15, 2015

(54) BEARING STRUCTURE FOR TURBOCHARGER

(71) Applicant: Osamu MAEDA, (US)

(72) Inventor: Osamu Maeda, Toyota-shi (JP)

(73) Assignee: TOYOTA JIDOSHA KABUSHIKI KAISHA, Toyota-shi (JP)

(21) Appl. No.: 14/438,529

(22) PCT Filed: Sep. 12, 2013
(86) PCT No.: PCT/JP13/74685

§ 371 Date: Apr. 24, 2015

(30) Foreign Application Priority Data
Nov. 2, 2012 (JP) 2012-242381

(51) Int. Cl. F16C 35/02; F04D 29/056; F16C 33/20

(52) U.S. Cl. CPC F16C 35/02; F16C 33/20; F04D 29/056

(57) ABSTRACT

A bearing structure for a turbocharger includes a center housing, which is arranged between a turbine wheel and a compressor wheel and has an insertion hole, a rotary shaft, which is inserted through the insertion hole and couples the turbine wheel to the compressor wheel, a pair of bearing members, which is press-fitted into the gap between the rotary shaft and the center housing and rotationally supports the rotary shaft, and a restriction member, which is held by the rotary shaft at a position between the bearing members and restricts the movement of the rotary shaft in the thrust direction by engaging with the bearing members. The bearing members have engagement surfaces engaging with the restriction member. An oil supply opening is formed in each of the engagement surfaces.

### TECHNICAL FIELD

The present invention relates to a bearing structure for a turbocharger for rotationally supporting a rotary shaft, which couples a turbine wheel and a compressor wheel together.

### BACKGROUND ART

Conventionally, a turbocharger using energy produced by exhaust gas is known as a forced-induction device for increasing output of an engine. A turbocharger includes a turbine wheel rotated by exhaust gas and a compressor wheel compressing intake air, which are coupled together by a rotary shaft. The rotary shaft is inserted through an insertion hole formed in a center housing and rotationally supported by the center housing via a thrust bearing and a radial bearing. Some of engine oil is supplied under pressure to the thrust bearing and the radial bearing to decrease frictional resistance and cool the rotary shaft. See, for example, Patent Document 1.

### PRIOR ART DOCUMENT

### Patent Document

Patent Document 1: Japanese Laid-Open Patent Publication No. 2011-220276

### SUMMARY OF THE INVENTION

### Problems that the Invention is to Solve

In the above-described turbocharger, some of the oil supplied under pressure to the bearing may leak into a turbine housing or a compressor housing through a seal for sealing the gap between the center housing and the rotary shaft.

It is an objective of the present invention to provide a bearing structure for a turbocharger capable of decreasing leakage of oil.

### Means for Solving the Problems

To achieve the foregoing objective and in accordance with one aspect of the present invention, a bearing structure for a turbocharger is provided that includes a center housing, a rotary shaft, a pair of bearing members, and a restriction member. The center housing is arranged between a turbine wheel and a compressor wheel and has an insertion hole. The rotary shaft is inserted through the insertion hole to couple the turbine wheel and the compressor wheel together. The bearing members are press-fitted in a gap between the rotary shaft and the center housing and rotationally support the rotary shaft. The restriction member is held by the rotary shaft at a position between the two bearing members and restricts movement of the rotary shaft in a thrust direction by being engaged with the bearing members. Each of the bearing members has an engagement surface engaged with the restriction member. An oil supply port is formed in each of the engagement surfaces.

In the bearing structure for a turbocharger, each of the bearing members receives radial force acting on the rotary shaft through an inner peripheral surface and thrust force acting on the rotary shaft through the engagement surface, which is engaged with the restriction member. Each bearing member supplies oil directly to a fluid layer of oil formed in the gap between the engagement surface and the restriction member through the oil supply port, which has an opening in the engagement surface. This makes it highly likely that oil will be supplied to the fluid layer, and thus reduce the amount of oil needed by the turbocharger. That is, the amount of oil supplied to the turbocharger is reduced so that leakage of the oil decreases.

In the above described turbocharger, the bearing members are preferably formed of plastic.

In this configuration, each bearing member is formed of plastic, which has elasticity superior to metal. This allows the bearing member to readily absorb of vibrations of the rotary shaft, thus restraining vibrations of the center housing and, furthermore, vibrations of the turbocharger.

In the above described turbocharger, each of the bearing members preferably includes an end portion located closer to the compressor wheel and an end portion located closer to the turbine wheel, and a recess is preferably formed in an outer periphery of at least one of the end portions.

In this configuration, the recess is formed in each bearing member and thus contact portions between the center housing and the bearing member are reduced. This reduces the number of transmission paths by which load applied by the rotary shaft is transmitted to the center housing through the bearing member. As a result, vibrations of the center housing caused by vibrations of the rotary shaft and, furthermore, vibrations of the turbocharger are restrained.

In the above described turbocharger, each of the bearing members is preferably formed of plastic and includes a recess formed in a portion of an outer periphery of the bearing member and a press-contact surface pressed against the center housing, and the press-contact surface is preferably formed by a superficial layer.

In this configuration, a difference in rigidity is caused in the axial direction of each bearing member. This promotes elastic deformation of the bearing member, thus promoting absorption of vibrations of the rotary shaft by the bearing member. As a result, vibrations of the center housing caused by vibrations of the rotary shaft and, furthermore, vibrations of the turbocharger are restrained.

In the above described turbocharger, the recess preferably includes a plurality of groove portions arranged in a circumferential direction and spaced apart at equal intervals. Alternatively, the recess is preferably one of a pair of recesses that extend along full circumferences of opposite end portions of each of the bearing members. Further, the recess preferably includes a groove portion that is formed in an axial middle portion of each of the bearing members and extends along a full circumference of the bearing member.

In the above-described configurations, since the recess or the groove portion is formed in each bearing member, contact portions between the center housing and the bearing member are reduced. This reduces the number of transmission paths by which load applied by the rotary shaft is transmitted to the center housing through the bearing member. As a result, vibrations of the center housing caused by vibrations of the rotary shaft and, furthermore, vibrations of the turbocharger are restrained.

In the above described turbocharger, the compressor wheel preferably includes a side wall portion surrounding an impeller portion.

In this configuration, the compressor wheel includes the side wall portion that surrounds the impeller portion. This makes it unlikely that the gas drawn into the compressor wheel will leak through the gap between the impeller portion and the compressor housing. As a result, even if the rotary shaft thermally expands to change the gap between the compressor wheel and the compressor housing, variations in forced induction performance of the turbocharger is reduced.

### BRIEF DESCRIPTION OF THE DRAWINGS

FIG. 1 is a cross-sectional view showing the configuration of a cross section a bearing structure for a turbocharger according a first embodiment of the present invention;

FIG. 2 is an enlarged view showing the portion surrounded by the long dashed short dashed line 2 in FIG. 1;

FIG. 3 is a perspective view showing a compressor wheel;

FIG. 4 is a perspective view showing a bearing member according to a second embodiment;

FIG. 5 is a cross-sectional view showing the bearing member of the second embodiment, illustrating a partial press-fit portion press-fitted in a center housing;

FIG. 6 is a perspective view showing a bearing member according to a third embodiment;

FIG. 7A is a cross-sectional view showing the bearing member of the third embodiment, illustrating an example of a cross-sectional shape of the bearing member immediately before the bearing member receives equal compression loads from a rotary shaft;

FIG. 7B is a cross-sectional view illustrating the bearing member immediately after the bearing member receives the equal compression loads from the rotary shaft;

FIG. 8 is a perspective view showing a bearing member according to a fourth embodiment;

FIG. 9A is a cross-sectional view showing the bearing member of the fourth embodiment, illustrating an example of a cross-sectional shape of the bearing member immediately before the bearing member receives equal compression loads from a rotary shaft;

FIG. 9B is a cross-sectional view illustrating an example of a cross-sectional shape of the bearing member immediately after the bearing member receives the equal compression loads from the rotary shaft; and

FIG. 10 is a cross-sectional view showing a bearing member and a center housing of a modified example.

### MODES FOR CARRYING OUT THE INVENTION

### First Embodiment

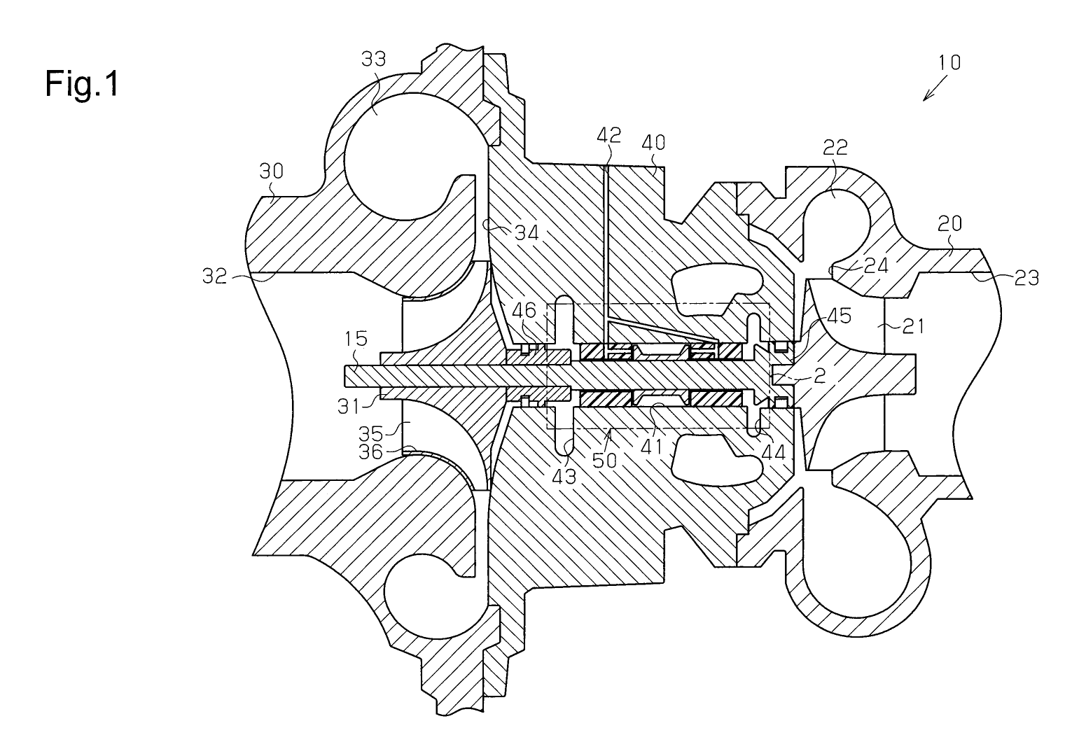

A bearing structure for a turbocharger according to a first embodiment will now be described with reference to FIGS. 1 to 3.

As illustrated in FIG. 1, a turbocharger 10 includes a turbine housing 20 for accommodating a turbine wheel 21 and a compressor housing 30 for accommodating a compressor wheel 31, which are joined to a center housing 40. That is, the center housing 40 is arranged between the turbine housing 20 and the compressor housing 30. The center housing 40 rotationally supports the rotary shaft 15, which couples the turbine wheel 21 and the compressor wheel 31 together, with a bearing portion 50.

The turbine housing 20 has a scroll passage 22, which extends to surround the outer periphery of the turbine wheel 21, and an exhaust port 23, which extends in the axial direction of the turbine wheel 21. The scroll passage 22 communicates with a non-illustrated exhaust passage of an internal combustion engine. Exhaust gas is delivered from a combustion chamber of the engine into the scroll passage 22 via the exhaust passage.

The turbine housing 20 has an inlet passage 24, which extends in a circumferential direction of the turbine wheel 21 to surround the outer periphery of the turbine wheel 21 and communicates with the scroll passage 22. Exhaust gas is blasted from the scroll passage 22 onto the turbine wheel 21 via the inlet passage 24. This rotates the turbine wheel 21 to rotate about the axis of the turbine wheel 21. The exhaust gas is then discharged into the exhaust port 23 and returned to the exhaust passage.

The compressor housing 30 has an inlet port 32, which extends in the axial direction of the compressor wheel 31, and a compressor passage 33, which extends to surround the outer periphery of the compressor wheel 31 and communicates with a non-illustrated intake passage of the engine. The compressor housing 30 also includes an outlet passage 34, through which the air introduced into the compressor housing 30 through the inlet port 32 is delivered to the compressor 33. When the rotary shaft 15 rotates to rotate the compressor wheel 31 about the axis, the air is delivered to the intake passage of the engine forcibly via the inlet port 32, the outlet passage 34, and the compressor passage 33. The compressor housing 30 includes an impeller portion 35 configured by a plurality of spiral blades and a side wall portion 36, which surrounds the outer periphery of the impeller portion 35.

In the turbocharger 10 having the above-described configuration, the exhaust gas discharged from the engine is blasted onto the turbine wheel 21 to rotate the turbine wheel 21. The compressor wheel 31, which is coupled to the turbine wheel 21 with the rotary shaft 15, is thus rotated to deliver the intake air forcibly into a combustion chamber of the engine.

The center housing 40 has an insertion hole 41, through which the rotary shaft 15 is inserted. The center housing 40 rotationally supports the rotary shaft 15 with the bearing portion 50, which is arranged in the insertion hole 41. An oil supply line 42, to which oil at a predetermined pressure is supplied from a non-illustrated pump, is formed in the center housing 40. The oil is thus supplied to the bearing portion 50 through the oil supply line 42. The oil, which has been supplied to the bearing portion 50, lubricates sliding portions and then returns to an oil pan through oil drainage lines 43, 44, which are formed in the center housing 40.

The center housing 40 is sealed by a sealing portion 45, which is arranged between the bearing portion 50 and the turbine wheel 21, with respect to the turbine housing 20. The center housing 40 is sealed also by a sealing portion 46, which is arranged between the bearing portion 50 and the compressor wheel 31, with respect to the compressor housing 30.

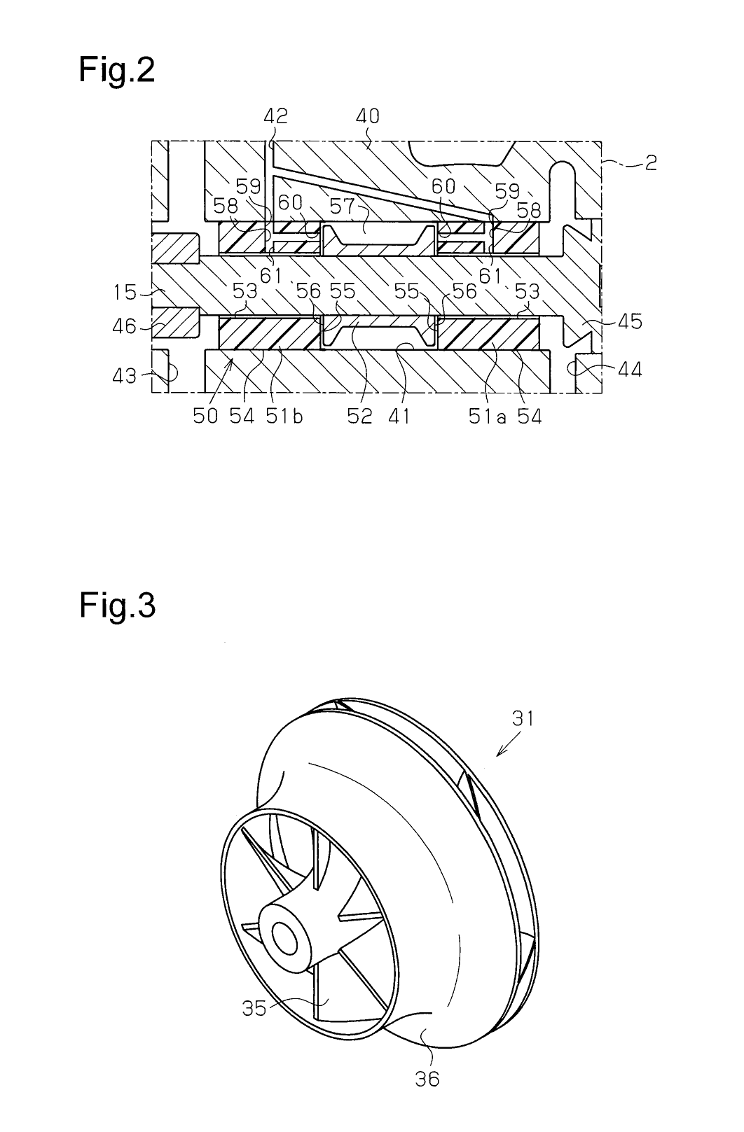

The bearing portion 50 of the turbocharger 10 will hereafter be described in detail with reference to FIG. 2. The bearing portion 50 includes a pair of bearing members 51a, 51b and a restriction member 52, which is arranged between the two bearing members 51a, 51b. The restriction member 52 is fixed to the rotary shaft 15 through shrinkage fit.

The bearing member 51a, which is located closer to the turbine wheel 21, and the bearing member 51b, which is located closer to the compressor wheel 31, are identically configured members that are arranged symmetrical with respect to a plane perpendicular to the axial direction of the rotary shaft 15. Therefore, the detailed description below is focused on the bearing member 51a. Same or like reference numerals are given to components of the bearing member 51b that have functions that are the same as or like functions of corresponding components of the bearing member 51a. Description of the bearing member 51b is omitted herein.

With reference to FIG. 2, the bearing member 51a has a cylindrical shape formed through molding of liquid-crystal polymer. The rotary shaft 15 is inserted in the space surrounded by an inner peripheral surface 53. The bearing member 51a is press-fitted into the insertion hole 41 and thus fixed to the center housing 40. An outer peripheral surface of the bearing member 51a as a whole is thus a press-contact surface 54, which is pressed against the center housing 40. That is, the bearing portion 50 receives radial force produced by the rotary shaft 15 through the inner peripheral surface 53 of the bearing member 51a.

Also, the bearing portion 50 receives thrust force produced by the rotary shaft 15 through engagement between an engagement surface 55, which is an end surface of the bearing member 51a, and an engagement surface 56, which is a corresponding end surface of the restriction member 52. The restriction member 52 is fixed substantially at a middle position between a coupling portion of the turbine wheel 21 and a coupling portion of the compressor wheel 31 with respect to the rotary shaft 15. The restriction member 52 has a cylindrical shape in which opposite end portions in the axial direction of the rotary shaft 15 have increased diameters. The gap between the restriction member 52 and the center housing 40 forms an internal oil chamber 57 in the space between the two bearing members 51a, 51b.

An oil guide line 58 is formed in the bearing member 51a. An oil inlet port 59 of the oil guide line 58 has an opening in the press-contact surface 54 of the bearing member 51a and communicates with the oil supply line 42, which is formed in the center housing 40. Oil is introduced into the oil guide line 58 through the oil inlet port 59 and flows out from a first oil supply port 60 having an opening in the engagement surface 55 of the bearing member 51a and a second oil supply port 61 having an opening in the inner peripheral surface 53 of the bearing member 51a. The oil flowing out from the first oil supply port 60 forms a first fluid layer in the gap between the bearing member 51a and the restriction member 52. The oil flowing out from the second oil supply port 61 forms a second fluid layer in the gap between the bearing member 51a and the rotary shaft 15. That is, the bearing portion 50 supports the rotary shaft 15 rotationally through the first and second fluid layers.

Operation of the bearing structure for the turbocharger 10 according to the first embodiment will now be described with reference to FIG. 3.

The above-described bearing structure for the turbocharger 10 receives the thrust force produced by the rotary shaft 15 through engagement between the engagement surfaces 55 of the bearing members 51a, 51b and the corresponding engagement surfaces 56 of the restriction member 52. The oil for forming the first fluid layer is supplied directly to the gaps between the bearing members 51a, 51b and the restriction member 52 through the first oil supply port 60. This makes it more likely that oil will be supplied to the aforementioned gaps than a case in which oil is indirectly supplied to the gaps between the bearing members 51a, 51b and the restriction member 52 via an oil supply port that is formed in the center housing 40 and has an opening communicating with the internal oil chamber 57. That is, the amount of oil needed to be supplied to the bearing portion 50 to form the first fluid layer is decreased. As a result, the amount of oil supplied to the turbocharger 10 is decreased so that leakage of the oil through the sealing portions 45, 46 is decreased.

In the bearing portion 50, the outer peripheral surface of the bearing member 51a is the press-contact surface 54, which is pressed against the center housing 40. This configuration does not need a fluid layer of oil in the boundary between the bearing member 51a and the center housing 40.

Therefore, compared to a configuration that needs fluid layers of oil in the gaps between the center housing 40 and the bearing members 51a, 51b, the amount of oil needed by the bearing portion 50 is decreased. As a result, the leakage of oil through the sealing portions 45, 46 is further decreased.

Also, reduction in the amount of oil needed by the bearing portion 50 allows the displacement of the pump for supplying the oil to the oil supply line 42 to be decreased. This increases the output of the engine employing the turbocharger 10 and improves fuel economy.

Specifically, in the configuration that needs the fluid layers of oil in the gaps between the bearing members 51a, 51b and the center housing 40, heated oil is introduced into the fluid layers and is thus likely to increase the temperature of the oil forming the first and second fluid layers. However, since the bearing portion 50 does not need fluid layers between the bearing members 51a, 51b and the center housing 40, a temperature rise in the oil of the first and second fluid layers is restrained. This improves cooling performance of the bearing portion 50, thus enhancing seizure-resistant performance of the turbocharger 10.

In the bearing portion 50, the oil is supplied directly to the gaps between the bearing members 51a, 51b and the restriction member 52 through the corresponding first oil supply ports 60. Also, the oil is supplied directly into the gaps between the bearing members 51a, 51b and the rotary shaft 15 through the corresponding second oil supply ports 61. That is, the oil is supplied directly to the respective sliding portions. This promotes circulation of the oil in each of the fluid layers and thus further improves the seizure-resistant performance of the turbocharger 10. Also, resistance of the oil to stirring at the time of rotation of the rotary shaft 15 is decreased and super induction efficiency of the turbocharger 10 is thus improved.

In the center housing 40, oil drainage lines 43, 44 for returning the oil that has been supplied to a bearing mechanism to the oil pan are formed between the two sealing portions 45, 46. In the above-described turbocharger 10, the restriction member 52 is arranged between the two bearing members 51a, 51b. Therefore, the engagement surfaces 55, 56 that receive the thrust force for moving the rotary shaft 15 toward the turbine wheel 21 are separate from the sealing portion 45 at least by the distance corresponding to the bearing member 51a. Also, the engagement surfaces 55, 56 that receive the thrust force for moving the rotary shaft 15 toward the compressor wheel 31 are separate from the sealing portion 46 at least by the distance corresponding to the bearing member 51b.

Therefore, compared to a case in which a bearing mechanism that receives thrust force is arranged adjacent to the sealing portion 45 or the sealing portion 46, drainage of oil before the oil reaches the sealing portion 45, 46 is promoted. This decreases the amount of oil that reaches the sealing portions 45, 46, thus decreasing leakage of the oil through the sealing portions 45, 46. Also, the bearing portion 50 does not need a sealing member that is necessary for a separate type thrust bearing, which is, for example, a bearing mechanism that receives thrust force. The number of components configuring the bearing mechanism that receives thrust force is thus decreased.

The restriction member 52 is fixed substantially at a middle position between the coupling portion of the compressor wheel 31 and the coupling portion of the turbine wheel 21 with respect to the rotary shaft 15. This improves mechanical strength of a portion corresponding to an antinode of a primary mode of vibrations of the rotary shaft 15, thus enhancing the performance of the bearing portion 50 of restraining vibrations of the rotary shaft 15.

Further, since the bearing members 51a, 51b are formed of plastic, the bearing members 51a, 51b are elastically deformed to absorb the radial force applied by the rotary shaft 15. That is, compared to a case in which bearing members are formed of metal, absorption of vibrations of the rotary shaft 15 by the bearing members 51a, 51b is promoted and transmission of the vibrations of the rotary shaft 15 to the center housing 40 is thus hampered. This restrains vibrations of the center housing 40 and, furthermore, vibrations of the turbocharger 10.

The compressor housing 30 is designed to constantly have a clearance between the compressor housing 30 and the compressor wheel 31 such that, even if the compressor housing 30 and the rotary shaft 15 both thermally expand, the compressor housing 30 does not interfere with the compressor wheel 31. Further, as the distance between the coupling portion of the compressor wheel 31 with respect to the rotary shaft 15 and the engagement surface 56 that receives the thrust force of the rotary shaft 15 becomes greater, the clearance is likely to be influenced by thermal expansion of the rotary shaft 15. That is, as the aforementioned distance becomes greater, the size of the clearance needed at the time of cooling becomes larger. If the clearance is enlarged in size, leakage of the intake air, which has been drawn into the compressor wheel, through the clearance is likely to occur.

As shown in FIG. 3, in the turbocharger 10, the compressor wheel 31 has a closed type impeller in which the outer periphery of the impeller portion 35 is surrounded by the side wall portion 36. This decreases leakage of the intake air, which has been drawn into the compressor wheel 31, through the aforementioned clearance. As a result, variation in super induction performance caused by thermal expansion of the rotary shaft 15 is decreased.

Also, the restriction member 52 is fixed substantially at the middle position between the coupling portion of the compressor wheel 31 and the coupling portion of the turbine wheel 21 with respect to the rotary shaft 15. This configuration disperses thermal expansion of the rotary shaft 15 to a portion closer to the compressor wheel 31 and a portion closer to the turbine wheel 21. Therefore, compared to a case in which the restriction member 52 is arranged close to the compressor wheel 31, the size of the clearance needed to be formed between the turbine housing 20 and the turbine wheel 21 is reduced. As a result, variation in super induction performance caused by the thermal expansion of the rotary shaft 15 is further decreased.

The bearing structure for the turbocharger 10 according to the first embodiment has the following advantages.

(1) Oil is supplied directly to the gaps between the bearing members 51a, 51b and the restriction member 52. This decreases the amount of oil needed by the bearing portion 50. Leakage of the oil through the sealing portions 45, 46 is thus decreased.

(2) The outer peripheral surface of each of the bearing members 51a, 51b is the press-contact surface 54, which is pressed against the center housing 40. The amount of oil needed by the bearing portion 50 is thus further decreased. This decreases the leakage of the oil through the sealing portions 45, 46.

(3) Since displacement of the pump decreases, output of the engine employing the turbocharger 10 is increased and fuel economy is improved.

(4) The oil for forming the first and second fluid layers is supplied directly to the respective fluid layers. This promotes circulation of the oil in each of the fluid layers, thus improving seizure-resistant performance of the turbocharger 10. The resistance of the oil to stirring by the rotary shaft 15 is also decreased and thus super induction efficiency of the turbocharger 10 is improved.

(5) Neither the gap between the bearing member 51a and the center housing 40 nor the gap between the bearing member 51b and the center housing 40 needs to include a fluid layer of oil. This restrains a temperature rise of the oil in the respective fluid layers. As a result, the seizure-resistance performance of the turbocharger 10 is improved.

(6) The engagement surfaces 55, 56 that receive thrust force are separate from the sealing portion 45 by the distance corresponding to the length of the bearing member 51a. This decreases the amount of oil that reaches the sealing portion 45, thus decreasing leakage of the oil through the sealing portion 45. Leakage of the oil through the sealing portion 46 is also decreased as in the case of the sealing portion 45.

(7) Since the bearing portion 50 does not need a sealing member, the number of components necessary for the bearing portion 50 and, furthermore, the number of components configuring the turbocharger 10 is decreased.

(8) The restriction member 52 is fixed substantially at the middle position between the coupling portion of the compressor wheel 31 and the coupling portion of the turbine wheel 21 with respect to the rotary shaft 15. This improves performance of the bearing portion 50 of restraining vibrations of the rotary shaft 15.

(9) Since the bearing members 51a, 51b are formed of plastic, absorption of vibrations of the rotary shaft 15 by the bearing members 51a, 51b is promoted. This restrains vibrations of the center housing 40 and, furthermore, vibrations of the turbocharger 10.

(10) In the turbocharger 10, the impeller portion 35 of the compressor wheel 31 is a closed type. This decreases variation in super induction performance caused by thermal expansion of the rotary shaft 15.

The first embodiment may be modified in the following forms as necessary.

At least one of the bearing members 51a, 51b may be formed of metal. In a case in which the bearing members 51a, 51b are formed of plastic, the plastic does not necessarily have to be liquid-crystal polymer but may be either polyether ether ketone or fluorine resin, which is a crystalline resin, or, alternatively, either polyarylate or polyamide imide, which is a non-crystalline resin. Also, in the case in which the bearing members 51a, 51b are formed of plastic, the plastic may be polyacetal, polyphenylene sulfide, or phenol resin.

The second oil supply ports 61 may be omitted in the bearing members 51a, 51b. That is, the oil introduced into each of the oil guide lines 58 may flow out simply from the first oil supply ports 60.

A plurality of first oil supply ports 60 may be formed in each of the bearing members 51a, 51b.

A plurality of second oil supply ports 61 may be formed in each of the bearing members 51a, 51b.

In the turbocharger 10, a plurality of oil supply lines 42 may be formed in the center housing 40 separately from one another. In this case, oil guide lines 58 communicating with the oil supply lines 42 are formed in the bearing members 51a, 51b separately from one another.

One of the two bearing members may be a semi-float type having a fluid layer of oil between the bearing member and the center housing 40.

### Second Embodiment

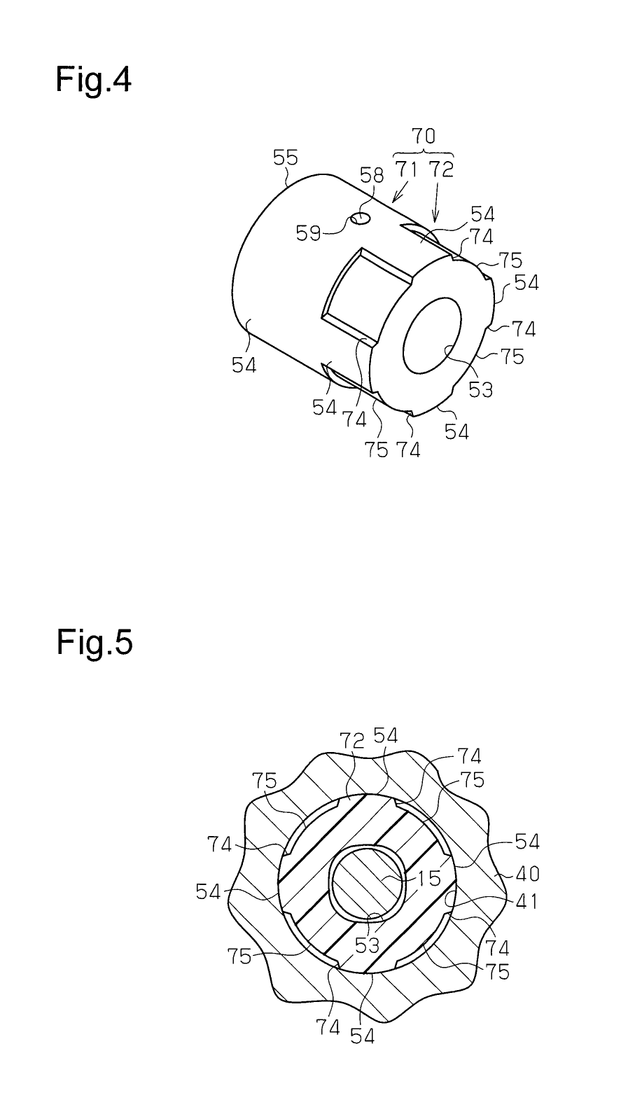

Next, a bearing structure for a turbocharger according to a second embodiment will be described with reference to FIGS. 4 and 5.

The bearing portion of the second embodiment is different from the bearing portion 50 of the first embodiment simply in the shapes of the bearing members 51a, 51b. The configurations of the other main components of the bearing portion of the second embodiment are identical with the configurations of the corresponding components of the bearing portion 50 of the first embodiment. Therefore, the description of the second embodiment is focused on bearing members. Same or like reference numerals are given to the components of the second embodiment that are the same as or like the corresponding components of the first embodiment and the detailed description of these components is omitted herein.

As illustrated in FIG. 4, a bearing member 70 of the second embodiment is a molded product of liquid crystal polymer. Four recesses extending in the axial direction of the bearing member 70, which are groove portions 74, are formed in the press-contact surface 54 in an end portion opposite to the engagement surface 55 and spaced apart at equal circumferential intervals. That is, the bearing member 70 is configured by a press-fit portion 71 and a partial press-fit portion 72. The press-fit portion 71 has the press-contact surface 54 extending on the entire outer peripheral surface in the circumferential direction of the bearing member 70. The partial press-fit portion 72 includes non-contact surfaces 75, which are formed at positions outside the press-fit portion 71 on the outer peripheral surface of the bearing member 70 extending in the circumferential direction. Each of the non-contact surfaces 75 does not contact the peripheral surface of the insertion hole 41.

The oil guide line 58 is formed in the press-fit portion 71. In the press-fit portion 71, a non-illustrated first oil supply line, the oil inlet port 59, and a non-illustrated second oil supply port are formed in the engagement surface 55, the press-contact surface 54, and the inner peripheral surface 53, respectively.

Operation of the bearing structure for the turbocharger 10 according to the second embodiment will be described with reference to FIG. 5.

When a pair of bearing members 70 is press-fitted in the insertion hole 41, the press-fit portion 71 of each of the bearing members 70 is located in the vicinity of the restriction member 52. The partial press-fit portion 72 of each bearing member 70 is arranged at the side opposite to the restriction member 52. In this state, in the press-fit portion 71 of each bearing member 70, the press-contact surface 54 is pressed against the center housing 40 to decrease oil flow into the gap between the bearing member 70 and the center housing 40.

In each bearing member 70, the non-contact surfaces 75 are formed in the partial press-fit portion 72. The contact area between the bearing member 70 and the center housing 40 is thus decreased correspondingly. That is, compared to a case in which the outer peripheral surface as a whole is the press-contact surface 54, the bearing member 70 has a small number of transmission paths via which vibrations of the rotary shaft 15 is transmitted to the center housing 40. This decreases transmission of the vibrations of the rotary shaft 15 through the bearing member 70, thus restraining vibrations of the center housing 40 caused by the vibrations of the rotary shaft 15 and, furthermore, vibrations of the turbocharger 10.

Further, portions of the rotary shaft 15 closer to the turbine wheel 21 or the compressor wheel 31 tend to have greater amplitudes of vibrations. That is, the portions of the rotary shaft 15 that tend to have greater amplitudes of vibrations are supported by each partial press-fit portion 72. As a result, vibrations of the center housing 40 caused by vibrations of the rotary shaft 15 and, furthermore, vibrations of the turbocharger 10 are efficiently restrained.

With reference to FIG. 5, in the partial press-fit portion 72, the press-contact surface 54 receives stress from the center housing 40, and the non-contact surfaces 75 do not receive stress from the center housing 40. Therefore, the amount of radial elastic deformation of the portion of each bearing member 70 including the press-contact surface 54 is greater than the amount of radial elastic deformation of the portion of the bearing member 70 including the non-contact surfaces 75. The cross-sectional shape of the inner peripheral surface 53 corresponding to the partial press-fit portion 72 thus becomes a shape including a plurality of arches. As a result, behavior of the rotary shaft 15 at the time of rotation is stabilized through wedge action of oil and thus performance of the bearing portion 50 of restraining vibrations of the rotary shaft 15 is improved.

Further, the partial press-fit portion 72 of the two bearing members 70 is arranged at the side opposite to the restriction member 52. This configuration ensures a desired surface area of the engagement surfaces 55 receiving thrust force, compared to a case in which the partial press-fit portion 72 of at least one of the bearing members 70 is arranged in the vicinity of the restriction member 52. Also, since the partial press-fit portion 72, which stably supports the rotary shaft 15, is arranged at a farther position, the performance of the bearing portion 50 of restraining vibrations of the rotary shaft 15 is efficiently improved.

Therefore, in addition to the advantages (1) to (10) of the first embodiment, the bearing structure for the turbocharger 10 of the second embodiment achieves the following advantages.

(11) The number of transmission paths via which vibrations of the rotary shaft 15 are transmitted to the center housing 40 is decreased. This restrains vibrations of the center housing 40 and, furthermore, vibrations of the turbocharger 10.

(12) The number of transmission paths is decreased at the side opposite to the restriction member 52. As a result, vibrations of the center housing 40 and, furthermore, vibrations of the turbocharger 10 are efficiently restrained.

(13) The cross-sectional shape of the inner peripheral surface 53 of each partial press-fit portion 72 includes a plurality of arches, thus improving performance of the bearing portion 50 of restraining vibrations of the rotary shaft 15.

(14) The partial press-fit portion 72 of the bearing members 70 is arranged at the side opposite to the restriction member 52. This ensures a sufficient surface area of each engagement surface 55 and efficiently improves the performance of the bearing portion 50 of restraining vibrations of the rotary shaft 15.

The second embodiment may be modified as follows.

The partial press-fit portion 72 of each bearing member 70 may be arranged in the vicinity of the restriction member 52. In this case, one of the end surfaces of the bearing member 70 that is in the vicinity of the partial press-fit portion 72 corresponds to the engagement surface 55. The first oil supply port 60 is thus formed in this end surface.

It is preferable to form at least three groove portions 74 in each partial press-fit portion 72 to improve performance of the bearing portion 50 of restraining vibrations of the rotary shaft 15. However, any other suitable configuration may be employed as long as the configuration includes at least one groove portion 74. Also, the outer peripheral surface of each partial press-fit portion 72 as a whole may be the non-contact surface 75. That is, the partial press-fit portion 72 may be configured in any other suitable manner as long as the partial press-fit portion 72 includes the non-contact surface 75 in at least a portion of the outer peripheral surface in the circumferential direction of the bearing member 70.

The groove portions 74 of each bearing member 70 may be formed by subjecting a cylindrical molded product to machining.

### Third Embodiment

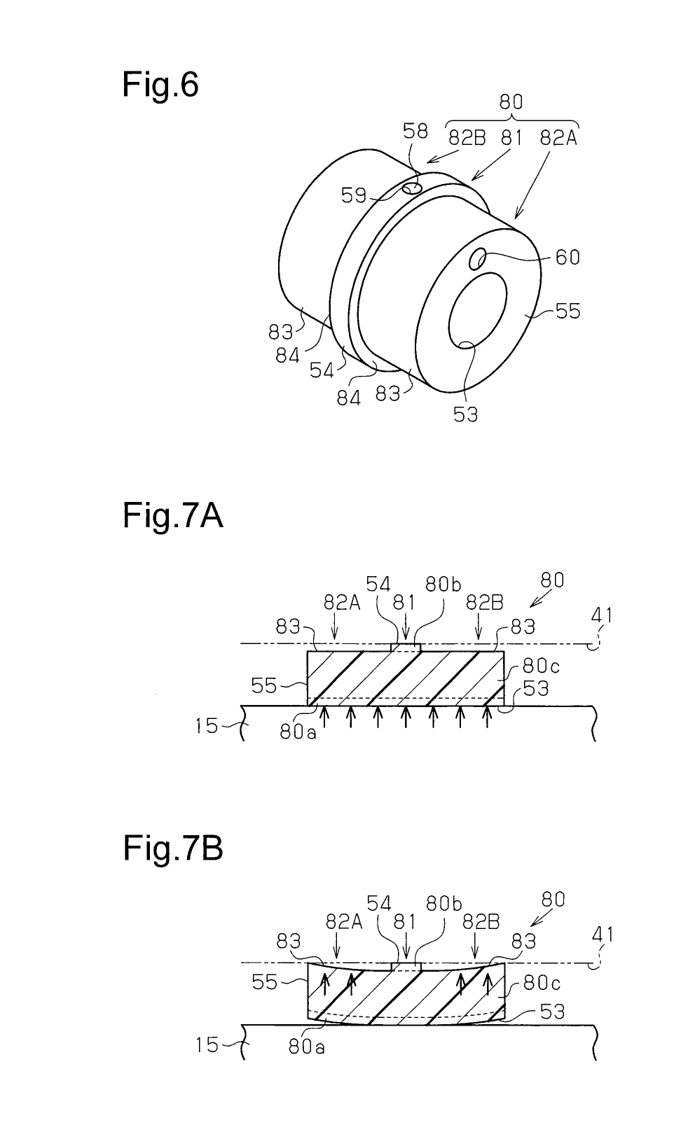

A bearing structure for a turbocharger according to a third embodiment of the present invention will now be described with reference to FIGS. 6 and 7.

A bearing portion of the third embodiment is different from the bearing portion 50 of the first embodiment simply in the shapes of the bearing members 51a, 51b. The configurations of other main components of the third embodiment are identical with the configurations of the corresponding components of the first embodiment. Therefore, the detailed description of the third embodiment is focused on the bearing members. Same or like reference numerals are given to components of the third embodiment that are the same as or like corresponding components of the first embodiment and description of these components is omitted herein.

As illustrated in FIG. 6, recesses 84 are formed in opposite end portions of a bearing member 80 of the third embodiment. Each of the recesses 84 extends circumferentially along the full circumference of the bearing member 80 and is formed as a cutout in the outer peripheral surface of the bearing 80. The recesses 84 are formed by subjecting a cylindrical molded product of liquid-crystal polymer to machining.

That is, in the bearing member 80, a press-fit portion 81 and non-press-fit portions 82A, 82B are formed integrally with one another. The outer peripheral surface of the press-fit portion 81 in the circumferential direction of the bearing member 80 as a whole is the press-contact surface 54. The outer peripheral surface of each of the non-press-fit portions 82A, 82B in the circumferential direction of the bearing member 80 as a whole is a non-contact surface 83, which does not contact the peripheral surface of the insertion hole 41. The non-press-fit portion 82A is a portion closer to of the engagement surface 55 with respect to the press-fit portion 81. The non-press-fit portion 82B is a portion at the side opposite to the engagement surface 55 with respect to the press-fit portion 81.

In a molded product of liquid crystal polymer, a superficial layer, which is a layer having highly oriented liquid crystal polymeric molecules, is easily formed in an outer surface of the molded product. Also, a core layer having low mechanical strength compared to the superficial layer is easily formed in the molded product. The recesses 84 are formed in the bearing member 80 by subjecting the molded product to machining. Therefore, in the bearing member 80, the press-contact surface 54, which is the outer peripheral surface of the press-fit portion 81, is formed in the superficial layer and the non-contact surfaces 83 of the non-press-fit portions 82A, 82B are formed in the core layer. Also, the inner peripheral surface 53 of the bearing member 80 as a whole is formed in the superficial layer. That is, the non-press-fit portions 82A, 82B do not include a superficial layer at least in their outer peripheral surfaces, the non-press-fit portions 82A, 82B exhibit low rigidity compared to the press-fit portion 81.

The oil inlet port 59 of the oil guide line 58 is formed in the press-contact surface 54 of the press-fit portion 81. A non-illustrated second supply port is formed in the inner peripheral surface 53 of the press-fit portion 81. The first oil supply port 60 is formed in the engagement surface 55 of the non-press-fit portion 82A.

With reference to FIG. 7, operation of the bearing structure for the turbocharger 10 according to the third embodiment will now be described. The drawing represents the boundary between the superficial layer and the core layer using a broken line.

Specifically, in a bearing member configured simply by the press-fit portion 81, the outer peripheral surface of the bearing member as a whole is pressed against the center housing 40. This configuration promotes limitation of shear deformation of the bearing member and elastic deformation of the core layer, which has low mechanical strength. As a result, particularly when the bearing member receives equal compression loads from the rotary shaft 15, or equal loads are applied to the bearing member in the axial direction of the bearing member, the bearing member is compressed and deformed mainly in a manner flattened by the rotary shaft 15. This hampers a vibration restraining effect through shear deformation.

However, in the bearing member 80, the non-press-fit portions 82A, 82B are formed at the opposite sides of the press-fit portion 81. That is, in the bearing member 80, the press-fit portion 81, which has high rigidity, is arranged between the non-press-fit portions 82A, 82B, which have low rigidity. The bearing member 80 thus causes a difference in rigidity in the axial direction of the bearing member 80. Further, the non-press-fit portions 82A, 82B are separate from the center housing 40. That is, the bearing member 80 promotes shear deformation of each non-press-fit portion 82A, 82B about the press-fit portion 81 as the support point and hampers limitation of elastic deformation of each non-press-fit portion 82A, 82B in the core layer.

Therefore, when equal compression load is instantaneously applied to a superficial layer 80a in the vicinity of the inner peripheral surface 53 as illustrated in FIG. 7A, the non-press-fit portions 82A, 82B, which have low rigidity, are shear-deformed about a superficial layer 80b of the press-fit portion 81, which has high rigidity, as the support point, referring to FIG. 7B. Also, the aforementioned load causes instantaneous elastic deformation of a core layer 80c. This promotes absorption of vibrations of the rotary shaft 15 by the bearing member 80, thus improving vibration restraining performance of the rotary shaft 15.

Further, since the two non-press-fit portions 82A, 82B are arranged at the opposite sides of the press-fit portion 81 of the bearing member 80, equal compression load is absorbed by the non-press-fit portions 82A, 82B. As a result, compared to a case in which a bearing member is configured by the press-fit portion 81 and one of the non-press-fit portions, the vibration restraining performance of the rotary shaft 15 is improved.

As has been described, the turbocharger 10 and the bearing structure for the turbocharger 10 of the third embodiment has the advantages described below, in addition to the advantages (1) to (10) of the first embodiment and the advantages (11) and (12) of the second embodiment.

(15) Since limitation of elastic deformation of each bearing member 80 is hampered, vibration restraining performance of the rotary shaft 15 is improved.

(16) In each bearing member 80, the non-press-fit portions 82A, 82B are formed at the opposite sides of the press-fit portion 81. As a result, compared to a case in which a bearing member is configured by the press-fit portion 81 and one of the non-press-fit portions, the vibration restraining performance of the rotary shaft 15 is improved.

The third embodiment may be modified in the following forms as necessary.

One of the non-press-fit portions 82A, 82B of each bearing member 80 may be omitted. That is, the bearing member 80 may be configured by a large diameter portion having the press-contact surface 54 and a small diameter portion having the non-contact surface 83.

As long as the outer peripheral surface of each non-press-fit portion 82A, 82B as a whole is a non-contact surface that is neither pressed against nor held in contact with the center housing 40, the outer peripheral surface may include dents and projections.

### Fourth Embodiment

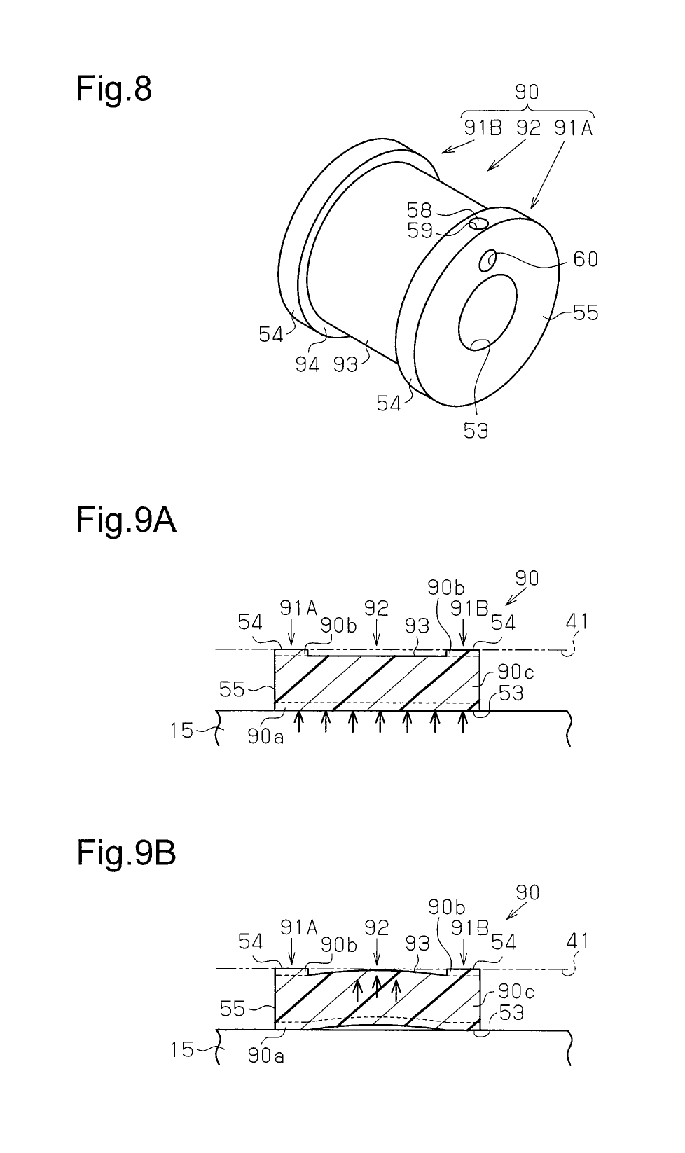

A bearing structure for a turbocharger according to a fourth embodiment will now be described with reference to FIGS. 8 and 9.

A bearing portion of the fourth embodiment is different from the bearing portion 50 of the first embodiment simply in the shapes of the bearing members 51a, 51b. The configurations of other main components of the fourth embodiment are identical with the configurations of the corresponding components of the first embodiment. Therefore, the detailed description of the fourth embodiment is focused on the bearing members. Same or like reference numerals are given to components of the fourth embodiment that are the same as or like corresponding components of the first embodiment and description of these components is omitted herein.

As illustrated in FIG. 8, a bearing member 90 of the fourth embodiment includes a recess formed in an axial middle portion of the bearing member 90 and extending circumferentially along the full circumference of the bearing member 90, which is a groove portion 94. The groove portion 94 is formed by subjecting a cylindrical molded product of liquid-crystal polymer to machining.

That is, in the bearing member 90, press-fit portions 91A, 91B and a non-press-fit portion 92 are formed integrally with one another. The outer peripheral surface of each of the press-fit portions 91A, 91B in the circumferential direction of the bearing member 80 as a whole is the press-contact surface 54. The outer peripheral surface of the non-press-fit portion 92 in the circumferential direction of the bearing member 80 as a whole is a non-contact surface 93, which does not contact the peripheral surface of the insertion hole 41. In the bearing member 90, the press-contact surface 54 of each press-fit portion 91A, 91B is formed in the superficial layer and the non-contact surface 93 of the non-press-fit portion 92 is formed in the core layer. Also, the inner peripheral surface 53 of the bearing member 90 as a whole is formed in the superficial layer. That is, since the non-press-fit portion 92 does not include a superficial layer at least in the outer peripheral surface of the non-press-fit portion 92, the non-press-fit portion 92 exhibits low rigidity compared to the press-fit portions 91A, 91B.

The oil inlet port 59 of the oil guide line 58 is formed in the press-contact surface 54 of the press-fit portion 91A. A non-illustrated second oil supply port is formed in the inner peripheral surface 53 of the non-press-fit portion 92.

With reference to FIG. 9, operation of the bearing structure for the turbocharger 10 according to the fourth embodiment will now be described. The drawing represents the boundary between the superficial layer and the core layer using a broken line.

Specifically, in a bearing member configured simply by the press-fit portion 91A, the outer peripheral surface of the bearing member as a whole is pressed against the center housing 40. This configuration promotes limitation of shear deformation of the bearing member and elastic deformation of the core layer, which has low mechanical strength.

However, in the bearing member 90, the non-press-fit portion 92 is formed between the press-fit portions 91A, 91B. That is, the bearing member 90 promotes shear deformation of the non-press-fit portion 92 about each press-fit portion 91A, 91B as the support point and hampers limitation of elastic deformation of the core layer in the non-press-fit portion 92.

Therefore, when instantaneous equal compression load is applied to a superficial layer 90a in the vicinity of the inner peripheral surface 53 as illustrated in FIG. 9A, the non-press-fit portion 92, which has low rigidity, is shear-deformed about a superficial layer 90b in each press-fit portion 91A, 91B, which has high rigidity, as the support points, referring to FIG. 9B. Also, the aforementioned load causes instantaneous elastic deformation of a core layer 90c.

As has been described, the bearing structure for the turbocharger 10 of the fourth embodiment has the advantages (1) to (10) of the first embodiment, the advantages (11) and (12) of the second embodiment, and the advantage (15) of the third embodiment.

The fourth embodiment may be modified in the following forms as necessary.

As long as the outer peripheral surface of the non-press-fit portion 92 as a whole is a non-contact surface that is neither pressed against nor held in contact with the center housing 40, the outer peripheral surface may include dents and projections.

The first to fourth embodiments may be modified as follows.

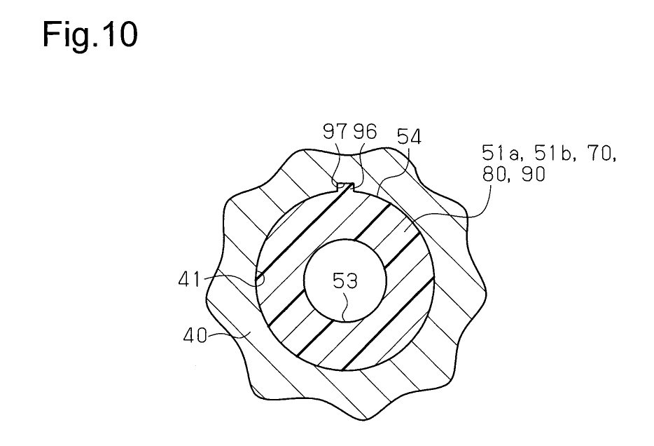

That is, with reference to FIG. 10, in the bearing portion 50 of each of the first to fourth embodiments, a key 96 extending in the axial direction may be projected from the press-contact surface 54 of the bearing member 51a, 51b, 70, 80, 90 at such a position that the key 96 does not interfere with the oil inlet port 59. In this case, a key groove 97 is formed in the peripheral surface of the insertion hole 41 of the center housing 40. This configuration facilitates positioning of the oil supply line 42 and the oil guide line 58 relative to each other.

1. A bearing structure for a turbocharger, comprising:
a center housing that is arranged between a turbine wheel and a compressor wheel and has an insertion hole;
a rotary shaft inserted through the insertion hole to couple the turbine wheel and the compressor wheel together;
a pair of bearing members that are press-fitted in a gap between the rotary shaft and the center housing and rotationally support the rotary shaft; and
a restriction member that is held by the rotary shaft at a position between the two bearing members and restricts movement of the rotary shaft in a thrust direction by being engaged with the bearing members, wherein
each of the bearing members has an engagement surface engaged with the restriction member, and
an oil supply port is formed in each of the engagement surfaces.

2. The bearing structure according to claim 1, wherein the bearing members are formed of plastic.

3. The bearing structure according to claim 1, wherein
each of the bearing members includes an end portion located closer to the compressor wheel and an end portion located closer to the turbine wheel, and
a recess is formed in an outer periphery of at least one of the end portions.

4. The bearing structure according to claim 1, wherein
each of the bearing members is formed of plastic and includes a recess formed in a portion of an outer periphery of the bearing member and a press-contact surface pressed against the center housing, and
the press-contact surface is formed by a superficial layer.

5. The bearing structure according to claim 1, wherein the recess includes a plurality of groove portions arranged in a circumferential direction and spaced apart at equal intervals.

6. The bearing structure according to claim 1, wherein the recess is one of a pair of recesses that extend along full circumferences of opposite end portions of each of the bearing members.

7. The bearing structure according to claim 1, wherein the recess includes a groove portion that is formed in an axial middle portion of each of the bearing members and extends along a full circumference of the bearing member.

8. The bearing structure according to claim 1, wherein the compressor wheel includes a side wall portion surrounding an impeller portion.
